(19) United States
(12) Patent Application Publication
(10) Pub. No.: US 2016/0263620 A1
(43) Pub. Date: Sep. 15, 2016

(54) METHOD OF MAKING PATTERNED ARTICLE

(71) Applicant: Taiwan Green Point Enterprises Co., Ltd., Taichung City (TW)

(72) Inventors: Li-Jun LI, Taichung City (TW); Wen-Bo WU, Taichung City (TW); Jian-Jun SUN, Taichung City (TW); Jian-Fang HU, Taichung City (TW)

(73) Assignee: Taiwan Green Point Enterprises Co., Ltd., Taichung City (TW)

(21) Appl. No.: 15/064,074

(22) Filed: Mar. 8, 2016

(30) Foreign Application Priority Data
Mar. 11, 2015 (CN) 201510104923.6

(51) Int. Cl. B05D 5/06; B05D 3/06; B23K 26/00

(52) U.S. Cl. CPC B05D 5/061; B23K 26/0087; B05D 3/06

(57) ABSTRACT

A method of making a patterned article includes: forming a shielding layer on a substrate; patterning the shielding layer and the substrate to form a cavity that extends through the shielding layer into the substrate so as to form a recess in the substrate, the recess being defined by a recess-defining surface of the substrate; forming a color layer on the recess-defining surface of the substrate so that the color layer is defined with an indentation; and removing the shielding layer after forming the color layer.

### CROSS-REFERENCE TO RELATED APPLICATION

This application claims priority of Chinese Patent Application No. 201510104923.6, filed on Mar. 11, 2015, which is incorporated by reference as if fully set forth.

### FIELD

The disclosure relates to a patterned article and a method for making the same, more particularly to a patterned article including a color layer with an indentation and a method of making the same.

### BACKGROUND

Chinese patent Application Publication No. 101992585A discloses a method of printing a decorative pattern on a surface of an article. The method includes: coating a protecting layer on a surface of an article; coating a masking layer on the protecting layer; patterning the masking layer, the protecting layer and the article to form a cavity that extends through the masking layer and the protecting layer into the article, so as to form a recess in the protecting layer and the article using laser engraving techniques; filling an ink in the cavity until the recess is completely filled; and removing the masking layer.

In the conventional method, the ink is completely filled in the recess, the article made thereby fails to provide a stereoscopic visual appearance and a three-dimensional tactile sensation.

### SUMMARY

Therefore, an object of the disclosure is to provide a method of making a patterned article that can alleviate at least one of the drawbacks of the prior art.

According to the disclosure, the method includes: forming a shielding layer on a substrate; patterning the shielding layer and the substrate to form at least one cavity that extends through the shielding layer into the substrate so as to form a recess in the substrate, the recess being defined by a recess-defining surface of the substrate; forming a color layer on the recess-defining surface of the substrate such that the color layer is defined with an indentation corresponding in position to the recess; and removing the shielding layer after forming the color layer.

Another object of the disclosure is to provide a patterned article.

According to the disclosure, the patterned article includes a substrate and a color layer.

The substrate is formed with a recess that is defined by a recess-defining surface.

The color layer is formed on the recess-defining surface and is defined with an indentation corresponding in position to the recess.

### BRIEF DESCRIPTION OF THE DRAWINGS

Other features and advantages of the disclosure will become apparent in the following detailed description of the embodiments with reference to the accompanying drawings, of which:

FIG. 1 is a flow chart illustrating an embodiment of a method of making a patterned article according to the disclosure;

FIG. 2 is a cross-sectional view illustrating step S1 of the embodiment;

FIG. 3 is a cross-sectional view illustrating step S2 of the embodiment;

FIG. 4 is a cross-sectional view illustrating step S3 of the embodiment;

FIG. 5 is a cross-sectional view illustrating step S4 of the embodiment; and

FIG. 6 is a cross-sectional view illustrating a patterned article made by the embodiment of the method shown in FIG. 1.

### DETAILED DESCRIPTION

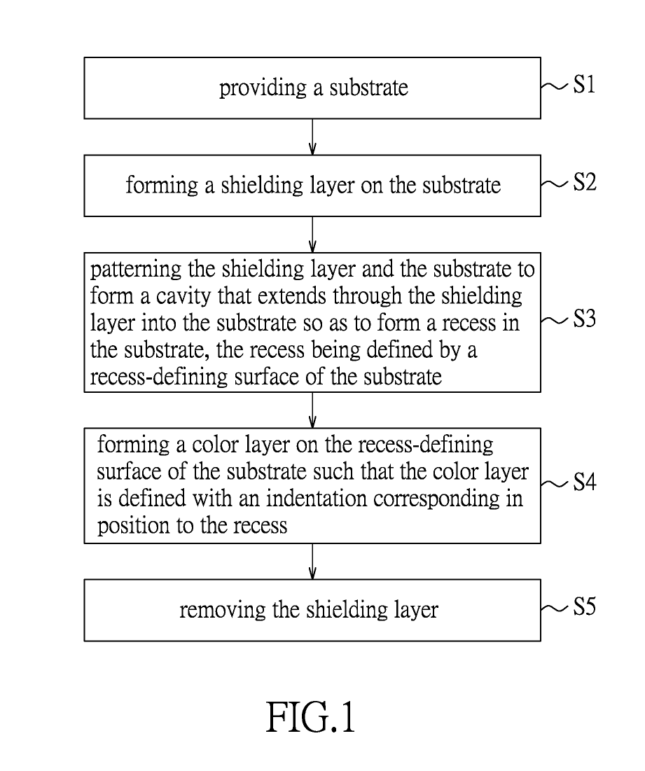

Referring to FIG. 1, an embodiment of a method of making a patterned article according to the disclosure includes steps S1 to S5.

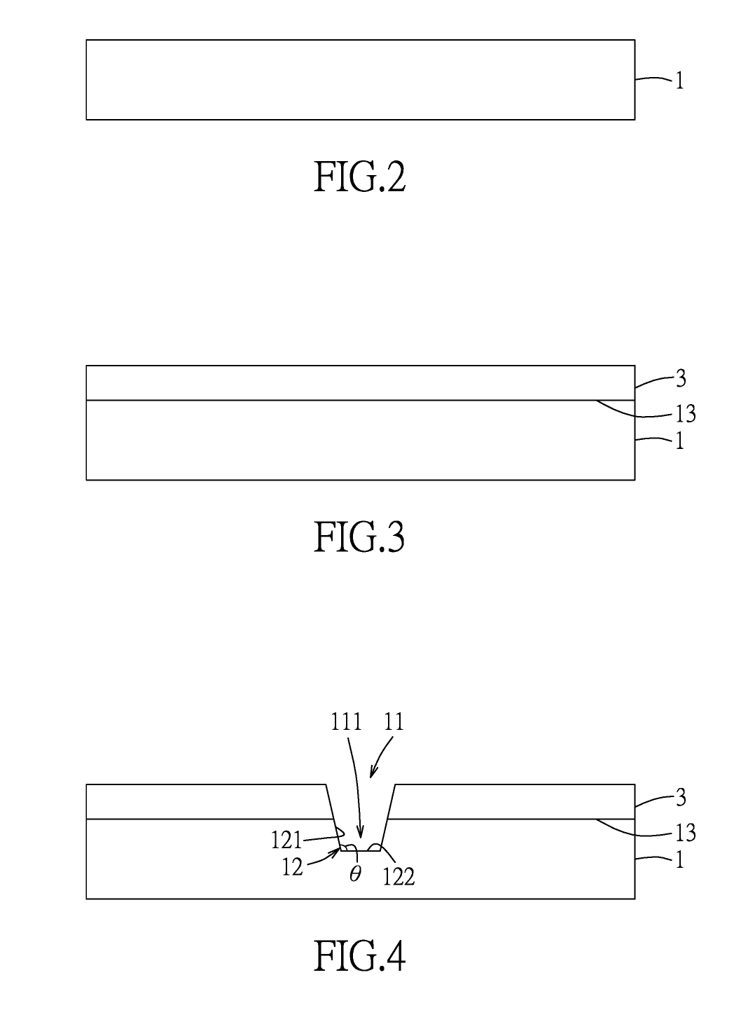

Referring to FIG. 2, instep S1, a substrate 1 is provided.

Referring to FIG. 3, instep S2, a shielding layer 3 is formed on the substrate 1. In this embodiment, the shielding layer 3 is formed by providing a coating solution on the substrate 1, followed by drying the coating solution. The coating solution may be provided by spray coating or printing techniques. The printing techniques may include, but is not limited to, a screen printing process, an ink-jet printing process, or a pad printing process. In this embodiment, the shielding layer 3 has a thickness from a top surface 13 of the substrate 1 ranging from 0.005 mm to 0.01 mm. Furthermore, the shielding layer 3 is removably formed on the substrate 1.

Referring to FIG. 4, in step S3, the shielding layer 3 and the substrate 1 are patterned to form at least one cavity 11 that extends through the shielding layer 3 into the substrate 1 so as to form a recess 111 in the substrate 1. The recess 111 is defined by a recess-defining surface 12 of the substrate 1. In certain embodiments, the shielding layer 3 and the substrate 1 maybe patterned to form a plurality of spaced apart cavities 11, and the cavities 11 cooperatively form a pattern on the substrate 1, such as a pattern of Mickey Mouse. In this embodiment, step S3 is performed using laser techniques in which a portion of the shielding layer 3 and a portion of the substrate 1 are heated and ablated by laser energy. The recess-defining surface 12 thus has structural characteristics indicative of the recess-defining surface 12 being formed by the laser techniques. In certain embodiments, step S3 may be performed using photolithography techniques. However, the laser techniques may be preferred due to its simplicity. In this embodiment, the recess-defining surface 12 of the substrate 1 includes a bottom face 122 and a surrounding face 121 that extends upwardly and outwardly from the bottom face 122. In this embodiment, the surrounding face 121 and the bottom face 122 cooperatively define an angle θ ranging between 100° and 145°.

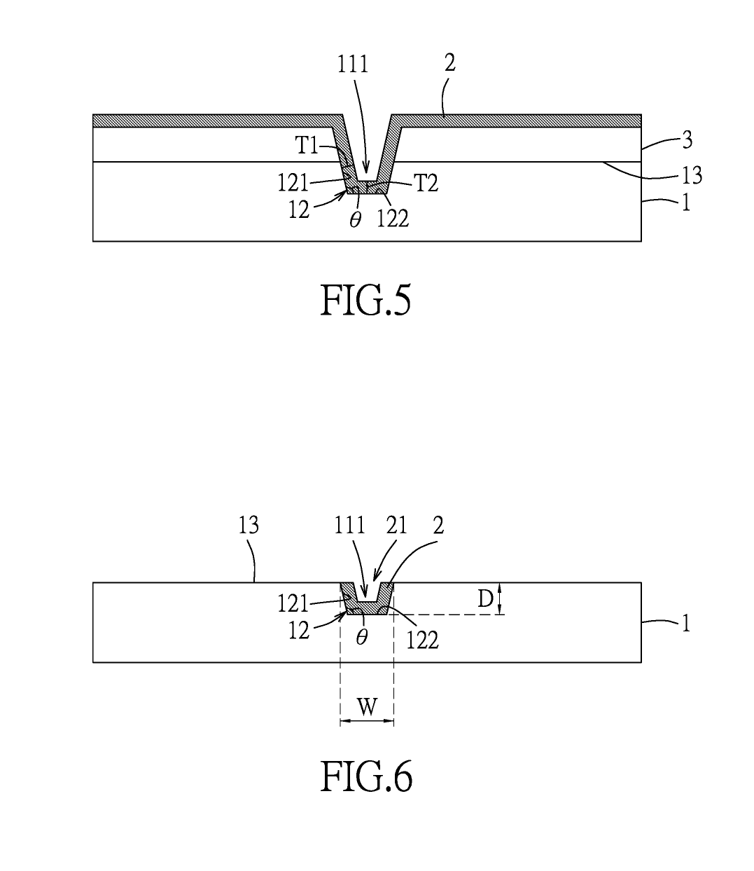

Referring to FIGS. 5 and 6, in step S4, a color layer 2 is formed on the recess-defining surface 12 of the substrate 1, so that the color layer 2 is defined with an indentation 21 corresponding in position to the recess 111. In other words, the recess 111 is not completely filled with the color layer 2. In certain embodiments, the color layer 2 may be made of a painting material (e.g. ink) that has high viscosity and that can be quickly solidified. In certain embodiment, the color layer 2 is made of an ink. By virtue of selected material used for forming the color layer 2 and control of the angle θ within 100° and 145°, the thickness and the coating area of the color layer 2 can be easily controlled, and the color layer 2 would not be accumulated on the bottom face 122 to prevent the recess 111 from being completely filled. In this embodiment, a ratio of the thickness (T1) of the color layer 2 on the surrounding face 121 to a thickness (T2) of the color layer 2 on the bottom face 122 is 3:5. In certain embodiments, the recess 111 has a maximum width (W) not smaller than 0.3 mm. The recess 111 further has a depth (D) measured from the top surface 13 of the substrate 1. A ratio of the depth (D) to the maximum width (W) is less than 1 so as to easily control the thickness of the color layer 2 in the recess 111.

In step S5, the shielding layer 3 along with the color layer 2 on the shielding layer 3 is removed after step S5 so as to form the patterned article including the substrate 1 and the color layer 2 (see FIG. 6).

The substrate 1 is formed with the recess 111 defined by the recess-defining surface 12 that includes the bottom face 122 and the surrounding face 121.

The color layer 2 is formed on the recess-defining surface 12 and is defined with an indentation 21 that corresponds in position to the recess 111.

To sum up, the color layer 2 is formed on the recess-defining surface 12 and is defined with the indentation 21, so that the recess 111 is not completely filled with the color layer 2. The patterned article thus has a three-dimensional tactile pattern and a stereoscopic visual appearance.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method of making a patterned article, comprising:
forming a shielding layer on a substrate;
patterning the shielding layer and the substrate to form at least one cavity that extends through the shielding layer into the substrate so as to form a recess in the substrate, the recess being defined by a recess-defining surface of the substrate;
forming a color layer on the recess-defining surface of the substrate so that the color layer is defined with an indentation corresponding in position to the recess; and
removing the shielding layer after forming the color layer.

2. The method as claimed in claim 1, wherein the recess-defining surface of the substrate includes a bottom face and a surrounding face that extends upwardly and outwardly from the bottom face.

3. The method as claimed in claim 2, wherein the surrounding face and the bottom face cooperatively define an angle ranging from 100° to 145°.

4. The method as claimed in claim 1, wherein the recess has a depth and a maximum width, and a ratio of the depth to the maximum width is less than 1.

5. The method as claimed in claim 1, wherein patterning the shielding layer and the substrate is performed using laser techniques.

6. The method as claimed in claim 1, wherein the shielding layer has a thickness from a top surface of the substrate ranging from 0.005 mm to 0.01 mm.

7. The method as claimed in claim 1, wherein, in the step of patterning the shielding layer and the substrate, a plurality of said cavities are formed, the cavities being spaced apart from one another and cooperatively forming a pattern on the substrate.

8. The method as claimed in claim 1, wherein the color layer is made of an ink.
